(19) United States
(12) Patent Application Publication
(10) Pub. No.: US 2003/0019837 A1
(43) Pub. Date: Jan. 30, 2003

(54) Method and apparatus for producing at least one depression in a semiconductor material

(76) Inventors: Alfred Kersch, Putzbrunn (DE); Winfried Sabisch, Munchen (DE)

Correspondence Address: LERNER AND GREENBERG, P.A., Post Office Box 2480, Hollywood, FL, 33022-2480, US

(21) Appl. No.: 10/208,498

(22) Filed: Jul. 30, 2002

(30) Foreign Application Priority Data
Jul. 30, 2001 (DE) 101 37 570.0

(51) Int. Cl. H01B 13/00

(52) U.S. Cl. 216/20

(57) ABSTRACT

A method and an apparatus for implementing the method produces at least one depression as a microstructure, in particular, a deep trench, in a semiconductor material, in particular, during the production of DRAMs and heats an area of at least one depression in the semiconductor material during an etching step, at least from time to time and/or locally. Such a configuration makes it possible to produce depressions in semiconductor materials efficiently, in particular, those with a high aspect ratio.

### BACKGROUND OF THE INVENTION

### FIELD OF THE INVENTION

The invention relates to a method of producing at least one depression as a microstructure, in particular, a deep trench, in a semiconductor material, in particular, during the production of DRAMs, and to an apparatus for implementing the method.

An important step in the production of DRAMs is the introduction of depressions as microstructures, in particular, deep trenches, into the surface of the semiconductor material. Here, different etching processes carry out the introduction of the depressions.

An important form of the depressions that are introduced into a semiconductor material are deep trenches. In a DRAM, the side walls of the deep trench function as a capacitor. Because the structures on a DRAM are continually becoming smaller, to maintain the capacitance of the capacitor, it is necessary to fabricate deep trenches with greater and greater depths. The aspect ratio (depth/diameter) of the deep trench is, therefore, becoming larger and larger. Typically, deep trenches have a diameter of less than 0.1 to 1 μm and a depth of 2 to 5 μm. However, depths of microstructures from 10 μm to 100 μm have been produced.

One problem here is that, in the familiar etching processes with an increasing aspect ratio of the depression, it becomes more difficult to produce the depressions rapidly and cleanly. The accessibility of the greater depths makes its difficult for the etching media to etch effectively.

### SUMMARY OF THE INVENTION

It is accordingly an object of the invention to provide a method and apparatus for producing at least one depression in a semiconductor material that overcomes the hereinafore-mentioned disadvantages of the heretofore-known devices and methods of this general type and that produces depressions in semiconductor materials efficiently, in particular, with a high aspect ratio.

With the foregoing and other objects in view, there is provided, in accordance with the invention, a method of producing a microstructure in a semiconductor material, including the step of producing at least one depression as a deep trench in a semiconductor material by at least one of intermittently and locally heating an area of the at least one depression in the semiconductor material during etching. Preferably, the semiconductor material forms a DRAM.

The fact that the area of at least one depression, in particular, a deep trench, in a semiconductor material is heated at least from time to time and/or locally during an etching step means that the recombination probability of reactive radicals in the depression is reduced. Such reduction leads to more reactive radicals being available for etching the depression so that more effective etching is possible precisely at great depths (that is to say, with a high aspect ratio of, for example, 20-30).

In accordance with another mode of the invention, the area of at least one depression in the semiconductor material is heated periodically during an etching step. Such heating avoids the situation in which the space in which the etching step is being carried out is heated too intensely. It is particularly advantageous here if the heating is carried out in a pulsed manner, in particular, with pulses from 10⁻⁵ to 10⁻⁷ seconds.

In accordance with a further mode of the invention, the portion of the volume close to the surface of the semiconductor material is heated down to a predefinable depth. It is particularly advantageous if the portion of the volume close to the surface of the semiconductor material is heated specifically down to a depth of 100 μm, preferably, of 5 to 30 μm. The depths of deep trenches lie in these ranges.

For the purpose of heating, use is advantageously made of an electromagnetic radiation source, in particular, a lamp and/or a laser, because these radiation sources can be controlled easily. In particular, these can advantageously be operated in a pulsed manner.

In accordance with an added feature of the invention, at least one electromagnetic radiation source operates continuously, the pulses being generated by a device for interrupting the radiation. A pulsed signal may, therefore, be generated in a simple way.

The heating of the portion of the volume close to the surface is advantageously carried out in a local temperature range from 200° C. up to the melting point, in particular, up to 1000° C., because, in such a range, the recombination probability of the radicals of the etching agent is particularly effectively reduced. A temperature of 1000° C. is still below the melting point but is sufficiently high to bring about an effective increase in concentration.

In accordance with an additional mode of the invention, reactive ion etching performs the etching step. Reactive ion etching is especially suitable, in particular, for the production of depressions such as deep trenches.

In addition, to reduce the recombination probability, it is advantageous to heat the wall of a reaction chamber, at least to some extent, for the etching step.

With the objects of the invention in view, there is also provided an apparatus for producing at least one depression in a semiconductor material, including a reaction chamber for holding the semiconductor material during processing, and a heater adapted to at least one of intermittently and locally heat a given area of at least one depression in the semiconductor material during etching of the semiconductor material. Preferably, the depression is a deep trench, the heating is periodic, and the semiconductor material forms a DRAM.

In accordance with yet another feature of the invention, the heater has a switching device or means for periodically heating the given area of the at least one depression in the semiconductor material during etching.

In accordance with yet a further feature of the invention, there is provided a device for pulsed heating, in particular, with pulses from 10⁻⁵ to 10⁻⁷ seconds, to prevent undesired heating.

In addition, it is advantageous, in accordance with yet an added feature of the invention, there is provided a device for heating the portion of the volume close to the surface of the semiconductor material down to a predefinable depth. The portion of the depression can, therefore, be heated specifically without, for example, undesired diffusion effects occurring in other portions of the semiconductor material.

In accordance with yet an additional feature of the invention, particularly effective heating may be achieved if the device for heating is configured as an electromagnetic radiation source, in particular, a lamp and/or a laser. This is true, in particular, if the lamp and/or laser can be operated in a pulsed manner to provide pulsed radiation.

In accordance with again another feature of the invention, it can also be advantageous if at least one electromagnetic radiation source operates continuously and a device for interrupting the radiation generates the pulses.

In accordance with a concomitant feature of the invention, to reduce the recombination probability, it is advantageous if the wall of a reaction chamber is heated, at least to some extent, for the etching step.

Other features that are considered as characteristic for the invention are set forth in the appended claims.

Although the invention is illustrated and described herein as embodied in a method and apparatus for producing at least one depression in a semiconductor material, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic cross-section of an apparatus for producing deep trenches by reactive ion etching (RIE);

FIG. 2 is a three-dimensional graph of a functional dependence of a theoretical maximum etching rate on an aspect ratio and a recombination probability of an etching agent;

FIG. 3 is a diagrammatic cross-section of a first embodiment of an apparatus according to the invention for producing a depression in a semiconductor material; and

FIG. 4 is a diagrammatic cross-section of a second embodiment of an apparatus according to the invention for producing a depression in a semiconductor material.

### DESCRIPTION OF THE PREFERRED EMBODIMENTS

In the following text, the etching of a deep trench by reactive ion etching (RIE) will be presented to illustrate the method according to the invention and the apparatus according to the invention. In principle, the method of the invention and the apparatus according to the invention are also suitable for the efficient production of other depressions in semiconductor material or for other etching processes.

One problem in the reactive ion etching of deep trenches is that the etching rate decreases with increasing depth (RIE lag), thus, the etching time increases.

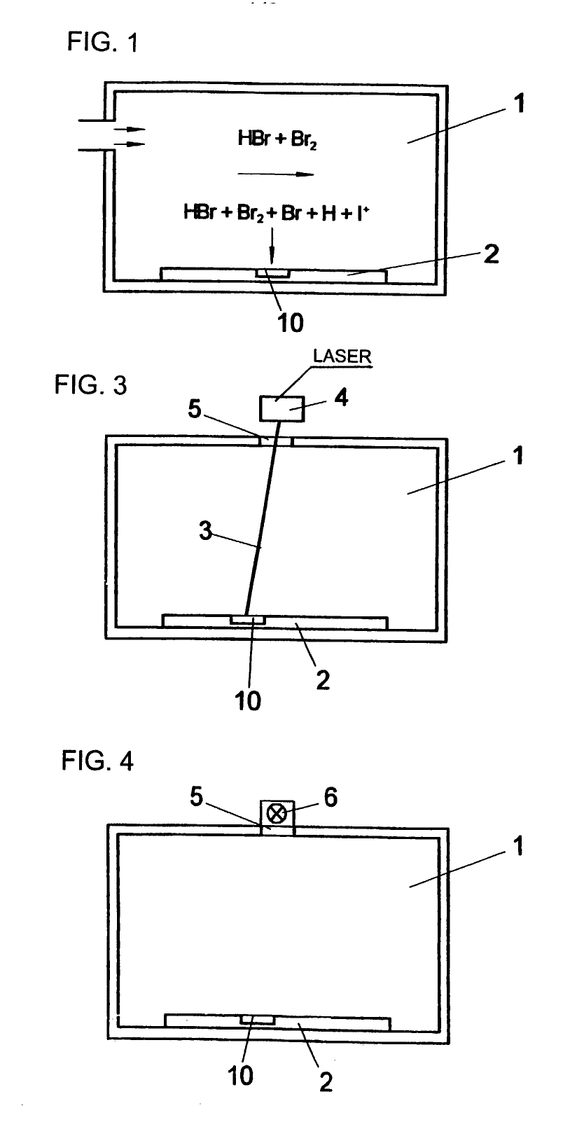

Referring now to the figures of the drawings in detail and first, particularly to FIG. 1 thereof, there is shown the basic principle of a conventional apparatus for the production of a deep trench 10 by means of RIE. Here, the etching in a silicon wafer 2 as semiconductor material is carried out with low-temperature plasma of moderate density containing halogen.

For explanatory purposes, a description will be given here of etching a schematically indicated deep trench 10 with a plasma produced by feeding HBr/Br₂ into a reaction chamber 1. In the reaction chamber 1, the plasma is produced by a high-frequency device, reactive radicals (Br here) being produced during the splitting of HBr or Br₂. In addition, ionized molecules I⁺are produced. There are usually other gases present, such as Cl₂ or mixtures, for example, with NF₃ and O₂.

In a first step, the Br radicals react with the silicon of the wafer 2, so that a brominated surface is produced.

The more weakly bound bromine-silicon compound can be separated from a surface of the wafer 2 as a result of the impact of a sufficiently high-energy ion I⁺. Two steps may be specified by the following reaction scheme:

S(s)+4Br(g)→SiBr₄(S)

I⁺+SiBr₄(s)→SiBr₄(g)

An improvement to the etching rate by increasing the HF throughput or increasing the pressure in the reaction chamber 1 has drawbacks on account of secondary effects (for example, energy loss of the ions in the plasma at higher pressures).

The heating of the semiconductor material proposed by the invention in this case leads to significantly better results in the production of the deep trenches 10.

The transport of the free radicals to the bottom of the deep trench 10 is limited by the Knudsen diffusion. The method according to the invention and the apparatus according to the invention begin to effect an improvement in the diffusive transport of the free radicals.

In the event of a lack of free radicals, the surface of the deep trench 10 cannot be etched effectively; the etching rate is very highly correlated with the consumption of radicals (virtually only SiBr₄ is produced as reactive product, no secondary products).

The transport of the radicals is limited by the magnitude of the Knudsen diffusion coefficient D_{knudsen} because the free path lengths are greater than the diameter of the deep trench 10. A longer transport path, therefore, leads to a lower radical concentration in the deep trench 10. In addition, recombination of the reactive radicals to form molecules of lower reactivity occurs (e.g., Br recombines to form Br₂ or with hydrogen to form HBr). Such recombination leads to an increased loss of radicals that are needed for the etching.

These relationships can be illustrated by a numerical solution of the following Knudsen diffusion transport equation:

$${D}_{K n u d s e n} \frac{{ⅆ}^{2} n}{ⅆ {x}^{2}} = γ \frac{v}{r} n$$

where:

x is the coordinate of the depth of the deep trench 10;

r is a radius of the deep trench 10;

n(x) is a concentration of free radicals as a function of the depth of the deep trench 10;

D^{Knudsen} is the Knudsen diffusion coefficient in the deep trench 10;

ν is the mean thermal velocity of the radicals; and

γ is the recombination probability when encountering the wall of the deep trench 10.

The solution to the equation for the concentration of the free radicals can be converted into a theoretical maximum etching rate. This has been carried out within the context of the present development.

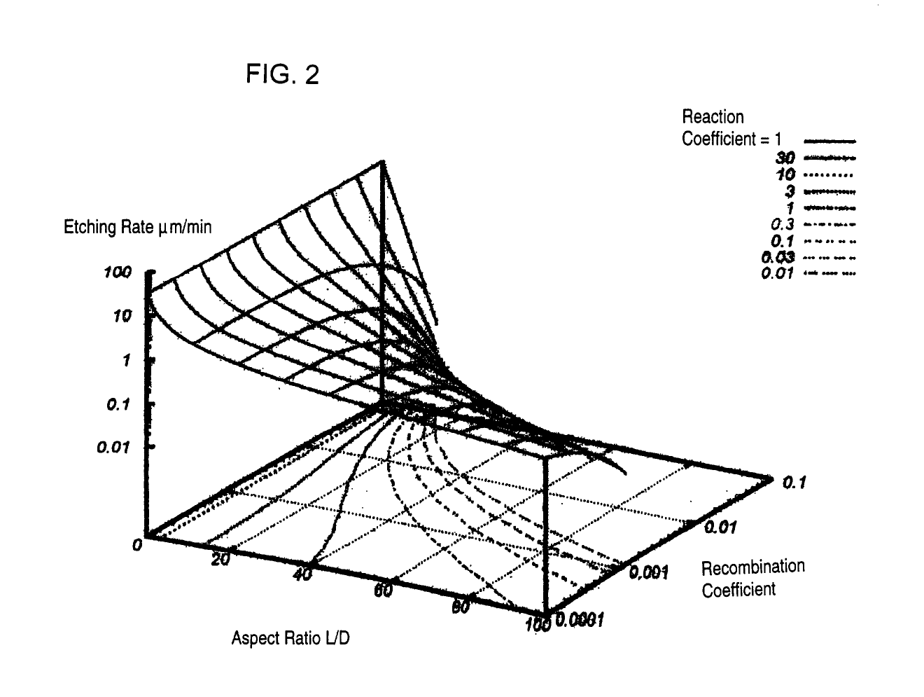

In FIG. 2, the theoretical maximum etching rate (z axis) is plotted as a function of the aspect ratio (L/D on the x-axis) and the recombination coefficient (y-axis). The reaction coefficient for the consumption of the ions is set to 1. The different lines in the x-y plane represents the projection of the etching rate.

FIG. 2 shows that, with a low recombination probability, that is to say, a high radical concentration, the maximum possible etching rate does not decrease very sharply even at high aspect ratios.

At higher recombination probabilities, this changes drastically, and the theoretical maximum possible etching rate decreases sharply even at low aspect ratios.

Measured etching rates during the etching of deep trenches 10 with HBr chemistry point to recombination probabilities of y=0.01 . . . 0.001.

Here, the recombination is the chemical reaction of a free radical encountering the wall of the deep trench with a radical weakly bound to the wall. Such weakly bound radicals are found in a physisorbed, not chemisorbed state. The binding energy in the physisorbed state is typically between 0.01 and 0.1 eV. Because of the relatively low binding energy, the radicals can be desorbed thermally.

Now, part of the knowledge in another field, specifically model trials on quartz (G. P. Kota et al., J. Vac. Sci. Technol. A17 (1999) 282), includes dependency of the recombination probability on temperature. The higher the temperature, the lower the recombination probability.

The invention is, then, based on the fact that heating the surface volume of the semiconductor material leads to a reduction in the recombination probability.

FIG. 3 represents a first embodiment of an apparatus according to the invention.

Disposed in the reaction chamber 1 is a silicon wafer 2 as the semiconductor material. DRAMs are to be produced on the wafer, in which, inter alia, deep trenches 10 are produced as depressions by reactive ion etching.

According to the invention, in the first embodiment, a laser beam 3 carries out heating of the portion of the volume close to the surface of the wafer 2. To prevent the entire reaction chamber 1 heating up or other portions of the semiconductor material heating up, the heating is carried out in a localized manner by the laser beam 3. The laser beam 3 is also pulsed, that is to say operated cyclically to avoid localized overheating. The pulse duration is about 10⁻⁶ s, with a power of about 160 W. As such, local temperatures of about 1000° C. are achieved in a range of 10 μm underneath the surface of the wafer 2.

The laser beam 3 is produced by a laser 4 as an electromagnetic radiation source. The laser 4 is disposed outside the reaction chamber 1. The laser beam 3 enters the reaction chamber through a quartz window 5 and, during the etching operation, is guided repeatedly over the wafer 2.

In a second embodiment, which is represented in FIG. 4, a pulsed lamp 6 is used as the electromagnetic radiation source. The pulse duration and the power correspond to the first embodiment; the heating of the wafer 2 is also comparable. The radiation from the lamp likewise enters the reaction chamber 1 through a quartz window 5. The pulsing of the lamp 6 can be brought about either by controlling the lamp or by influencing the radiation externally, for example, by a chopper. A chopper can be formed, for example, by a rapidly rotating perforated disk.

To reduce recombination of radicals at the walls of the reaction chamber 1, these walls are heated in the embodiment.

In its configuration, the invention is not restricted to the preferred exemplary embodiments indicated above. Instead, variants are conceivable to make use of the method according to the invention and the apparatus according to the invention, even in fundamentally different constructions.

We claim:

1. A method of producing a microstructure in a semiconductor material, which comprises:
producing at least one depression as a deep trench in a semiconductor material by at least one of intermittently and locally heating an area of the at least one depression in the semiconductor material during etching.

2. The method according to claim 1, which further comprises periodically heating the area of the at least one depression during etching.

3. The method according to claim 2, which further comprises carrying out the periodic heating in a pulsed manner.

4. The method according to claim 2, which further comprises carrying out the periodic heating with pulses having a duration between 10⁻⁵ and 10⁻⁷ seconds.

5. The method according to claim 1, which further comprises heating a portion of a volume adjacent a surface of the semiconductor material down to a predefined depth.

6. The method according to claim 5, which further comprises heating the portion of the volume adjacent the surface of the semiconductor material down to a depth of approximately 100 μm.

7. The method according to claim 5, which further comprises heating the portion of the volume adjacent the surface of the semiconductor material down to a depth of between 5 and 30 μm.

8. The method according to claim 1, which further comprises heating the area with at least one electromagnetic radiation source.

9. The method according to claim 1, which further comprises heating the area with a heater selected from at least one of the group consisting of a lamp and a laser.

10. The method according to claim 7, which further comprises heating the area with a heater selected from at least one of the group consisting of a lamp and a laser.

11. The method according to claim 8, which further comprises operating the heater in a pulsed manner.

12. The method according to claim 10, which further comprises operating the heater in a pulsed manner.

13. The method according to claim 8, which further comprises:
operating the at least one electromagnetic radiation source continuously; and
generating pulses with the electromagnetic radiation source by interrupting radiation therefrom.

14. The method according to claim 5, which further comprises carrying out the heating of the portion at a local temperature from approximately 200° C. up to a melting point of the semiconductor material.

15. The method according to claim 5, which further comprises carrying out the heating of the portion at a local temperature between 200° C. and 1000° C.

16. The method according to claim 1, wherein the etching is reactive ion etching.

17. The method according to claim 1, which further comprises:
carrying out the production step in a reaction chamber; and heating at least a portion of a wall of the reaction chamber during etching.

18. A method of producing a microstructure in a semiconductor material, which comprises:
producing at least one depression in a semiconductor material by at least one of periodically and locally heating an area of the at least one depression in the semiconductor material during etching.

19. A method of producing a microstructure in a semiconductor material forming a DRAM, which comprises:
producing at least one depression of a DRAM as a deep trench in a semiconductor material by at least one of periodically and locally heating an area of the at least one depression in the semiconductor material during etching.

20. An apparatus for producing at least one depression in a semiconductor material, comprising:
a reaction chamber for holding the semiconductor material during processing; and
a heater adapted to at least one of intermittently and locally heat a given area of at least one depression in the semiconductor material during etching of the semiconductor material.

21. The apparatus according to claim 20, wherein said heater has a means for periodically heating the given area of the at least one depression in the semiconductor material during etching.

22. The apparatus according to claim 20, wherein said heater has switching device for periodically heating the given area of the at least one depression in the semiconductor material during etching.

23. The apparatus according to claim 20, wherein said heater has a means for pulsed heating of the given area of the at least one depression in the semiconductor material.

24. The apparatus according to claim 20, wherein said heater has a means for heating the given area of the at least one depression in the semiconductor material with pulses having a duration between 10⁻⁵ and 10⁻⁷ seconds.

25. The apparatus according to claim 20, wherein said heater has a pulsed heater adapted to heat the given area of the at least one depression in the semiconductor material in a pulsed manner.

26. The apparatus according to claim 20, wherein said heater has a pulsed heater adapted to heat the given area of the at least one depression in the semiconductor material with pulses having a duration between 10⁻⁵ and 10⁻⁷ seconds.

27. The apparatus according to claim 20, wherein:
the semiconductor material has a surface; and
the heater has a means for heating a portion of a volume adjacent the surface of the semiconductor material down to a predefined depth.

28. The apparatus according to claim 20, wherein:
the semiconductor material has a surface; and
the heater is adapted to heat a portion of a volume adjacent the surface of the semiconductor material down to a predefined depth.

29. The apparatus according to claim 20, wherein said heater is at least one electromagnetic radiation source.

30. The apparatus according to claim 29, wherein said at least one radiation source is at least one of the group consisting of a lamp and a laser.

31. The apparatus according to claim 29, wherein said at least one radiation source provides pulsed radiation.

32. The apparatus according to claim 31, wherein:
said at least one radiation source operates continuously; and
said pulsed radiation is interrupted pulse radiation.

33. The apparatus according to claim 31, wherein:
said at least one radiation source operates continuously; and
said pulsed radiation is created by interruptions.

34. The apparatus according to claim 20, wherein:
said reaction chamber has a wall; and
at least a portion of said wall heats during etching.

35. The apparatus according to claim 20, wherein:
said reaction chamber has a wall; and
a wall heater heats at least a portion of said wall during etching.

36. An apparatus for producing at least one depression in a semiconductor material, comprising:
a reaction chamber for holding the semiconductor material during processing; and
a heater adapted to at least one of intermittently and locally heat a given area of at least a deep trench in the semiconductor material during etching of the semiconductor material.

37. An apparatus for producing at least one depression in a semiconductor material forming a DRAM, comprising:
a reaction chamber for holding the semiconductor material of the DRAM during processing; and
a heater adapted to at least one of intermittently and locally heat a given area of at least a deep trench in the semiconductor material of the DRAM during etching of the semiconductor material.
